(19) United States
(12) Patent Application Publication
(10) Pub. No.: US 2009/0129892 A1
(43) Pub. Date: May 21, 2009

(54) Book-binding system

(75) Inventor: Hiroki Okada, Yokohama-shi (JP)

Correspondence Address: HARNESS, DICKEY & PIERCE, P.L.C., P.O. BOX 8910, RESTON, VA, 20195, US

(73) Assignee: RICOH COMPANY, LTD.

(21) Appl. No.: 12/292,314

(22) Filed: Nov. 17, 2008

(30) Foreign Application Priority Data
Nov. 20, 2007 (JP) 2007-300485
May 30, 2008 (JP) 2008-142010

(51) Int. Cl. B42C 13/00

(52) U.S. Cl. 412/11

(57) ABSTRACT

A book-binding system includes an image forming apparatus, a binder, a detector, and an operation unit. The image forming apparatus forms images on a plurality of sheets. The binder is connectable to the image forming apparatus and binds with a binding member the plurality of sheets on which the images are formed by the image forming apparatus. The detector acquires information on the plurality of sheets fed from the image forming apparatus to the binder and information on consumables used to bind the plurality of sheets. The operation unit displays the information on the consumables in a selectable manner for input. The input from the operation unit allows selection of consumables depending on the number and type of sheets bound in the binder.

### CROSS-REFERENCE TO RELATED APPLICATIONS

The present patent application claims priority pursuant to 35 U.S.C. §119 from Japanese Patent Application Nos. 2007-300485, filed on Nov. 20, 2007, and 2008-142010, filed on May 30, 2008 in the Japan Patent Office, the entire contents of each of which are hereby incorporated herein by reference.

### BACKGROUND OF THE INVENTION

1. Field of the Invention

The present invention relates to a book-binding system connectable to an image forming apparatus, such as a copier or a printer, and capable of automatically binding a plurality of sheets with a binding member such as staples, rings, or tape.

2. Description of the Background

As a conventional book-binding device, a finisher is known that binds and staples a predetermined number of sheets output from a copier connected to the device. The finisher is capable of storing a plurality of different types of staples and selecting the appropriate type to use depending on sheet thickness.

Further, in a conventional-post-processing machine, a staple cartridge is detachably mountable to enable use of several different types of staples. A conventional binder uses rings to bind a predetermined number of sheets. A conventional sheet processing apparatus has a sheet conveyance unit to convey a sheet to a predetermined position, a punching unit to punch a hole at one end portion of the sheet, a binder sheet alignment unit to align a plurality of punched sheets, and a binding unit to bind the punched sheets in book form.

Still further, in a conventional book binding device, a binder cartridge is movable in a relatively smooth manner and mountable in a relatively easy manner.

A conventional post-processing machine like that described above may be connected to an image forming apparatus and capable of processing sheets printed by the image forming apparatus. The post-processing machine binds an end or a middle portion of a sheet stack and presses an edge portion of the sheet stack against adhesive tape to produce a book. Further, the post-processing machine may punch multiple holes around a bound side of the sheet stack and bind the sheet stack with a metal coil or plastic ring to produce a ring-bound book.

### SUMMARY OF THE INVENTION

This patent specification describes a book-binding system that enables easy selection of a desired type of book binding consumable from among a plurality of types of book binding consumables.

In one illustrative embodiment, the book-binding system includes an image forming apparatus, a binder, a detector, and an operation unit. The image forming apparatus forms images on a plurality of sheets. The binder is connectable to the image forming apparatus and binds with a binding member the plurality of sheets on which the images are formed by the image forming apparatus. The detector acquires information on the plurality of sheets fed from the image forming apparatus to the binder and information on consumables used to bind the plurality of sheets. The operation unit displays the information on the consumables in a selectable manner for input. The input from the operation unit allows selection of different types of consumables depending on the number and type of sheets bound in the binder.

### BRIEF DESCRIPTION OF THE DRAWINGS

A more complete appreciation of the disclosure and many of the attendant advantages thereof will be readily acquired as the same becomes better understood by reference to the following detailed description when considered in connection with the accompanying drawings, wherein:

FIG. 1 is a schematic view illustrating a book-binding system, in which a post-processing machine is connected to an image forming apparatus according to an illustrative embodiment of the present disclosure;

FIG. 2 is a schematic view illustrating a structure of a ring-binding binder usable in the book-binding system of FIG. 1;

FIG. 3 is a block diagram illustrating one configuration of the book-binding system of FIG. 1;

FIG. 4 is a flow chart illustrating a procedure for acquiring information on compatible consumables when binding;

FIG. 5 is a diagram illustrating a series of screen displays (a) to (c) in which one consumable type is selected via a control panel;

FIG. 6A is a schematic view illustrating a configuration of a ring cartridge storing a plurality of different types of rings;

FIG. 6B is a schematic view illustrating another configuration of a ring cartridge storing a plurality of different types of rings;

FIG. 7 is a schematic view illustrating a sensor to detect a ring;

FIG. 8A is a schematic view illustrating a configuration of a ring cartridge indicative of information on rings stored in the cartridge;

FIG. 8B is a schematic view illustrating another configuration of a ring cartridge indicative of information on rings stored in the cartridge;

FIG. 9 is a diagram illustrating screen displays (a) and (b) of a screen for setting a color for a consumable (in this example, a ring) from a control panel;

FIG. 10 is a diagram illustrating screen displays (a) and (b) of a screen for setting a color for a consumable (in this example, tape) from a control panel;

FIG. 11 is a flow chart illustrating a procedure for selecting a compatible consumable type when binding;

FIG. 12 is a diagram illustrating a display example of a selection screen;

FIG. 13 is a diagram illustrating a display example of a selection screen on which all types of mountable consumables are displayed; and

FIG. 14 is a diagram illustrating a display example of an alert screen.

The accompanying drawings are intended to depict illustrative embodiments of the present disclosure and should not be interpreted to limit the scope thereof. The accompanying drawings are not to be considered as drawn to scale unless explicitly noted.

### DETAILED DESCRIPTION OF ILLUSTRATIVE EMBODIMENTS

In describing embodiments illustrated in the drawings, specific terminology is employed for the sake of clarity. However, the disclosure of this patent specification is not intended to be limited to the specific terminology so selected and it is to be understood that each specific element includes all technical equivalents that operate in a similar manner and achieve similar results.

Below, illustrative embodiments are described with reference to the drawings.

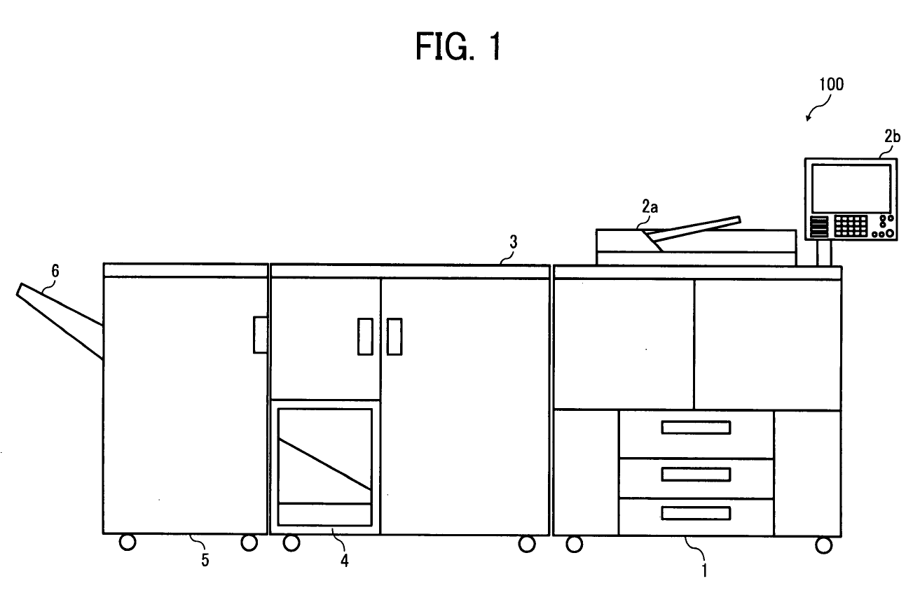

FIG. 1 is a schematic view illustrating a book binding system, in which a post-processing machine is connected to an image forming apparatus according to an illustrative embodiment of the present disclosure.

Below, a description is given of a configuration of a book-binding system 100 with reference to FIG. 1.

In FIG. 1, an image forming apparatus 1 is illustrated as a multi-functional printer (MFP), and includes an automatic document feeder (ADF) 2a and a control panel 2b with a display unit. It is to be noted that the image forming apparatus according to the present invention is not limited to the MFP, but may be any other suitable type of image forming apparatus.

On a downstream side of the image forming apparatus 1 in the book-binding system 100, a binder 3, such as a ring or tape binding device, is connected to the image forming apparatus 1. In the binder 3, a plurality of sheets to be bound as a book is aligned, bound with rings or tape, and output in book form to an output tray 4.

Further, on the extreme downstream end of the book-binding system 100, a post-processing machine 5 is connected to the binder 3. The post-processing machine 5 includes a punching device, a staple device, and/or other devices, and is capable of performing a plurality of different types of stapling and sheet alignment operations.

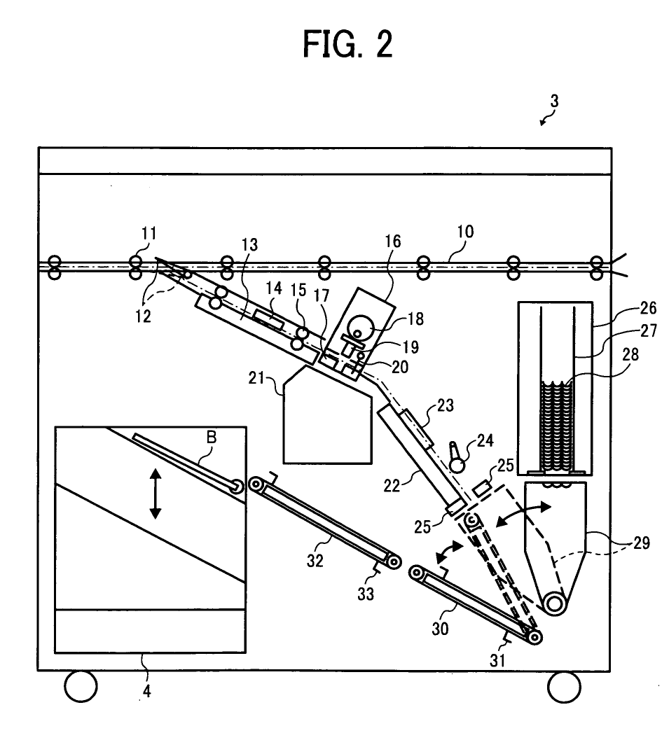

FIG. 2 is a schematic view illustrating a structure of the binder 3 of ring-binding type according to this embodiment. It is to be noted that, when a binder according to another embodiment is a tape-binding type, the tape-binding binder can also perform book binding using a process route similar to the ring-binding binder 3 illustrated in FIG. 2 described below.

Below, a description is given of the structure, operation, and function of the binder 3 with reference to FIG. 2.

A sheet fed from the image forming apparatus 1 is conveyed through a horizontal path 10 of the binder 3. When the sheet is not bound with a ring(s), the sheet is further conveyed in a horizontal direction to the post-processing machine 5 disposed on the downstream side of the binder 3.

By contrast, when the sheet is bound with a ring(s), the conveyance direction of sheet is switched back using reverse rollers 11. At this time, the orientation of a switching claw 12 is changed so that the sheet is conveyed to a punching unit 16 disposed obliquely below the switching claw 12. In the punching unit 16, a jogger 14 aligns one side of the sheet on an alignment tray 13 and the sheet is contacted against a stopper 20, so that the sheet is positioned in both a conveyance direction and a lateral direction perpendicular to the conveyance direction.

When the sheet contacts the stopper 20, a conveyance roller 15 with a torque limiter applies a conveyance force to the sheet, thereby preventing the front tip of the sheet from being damaged. When the sheet is positioned, a cam 18 within the punching unit 16 rotates to push a punch 19 down, so that the sheet is punched between the punch 19 and a die 17. In this illustrative embodiment, the punching unit 16 is capable of punching a plurality of holes for ring binding. Below the punching unit 16 is disposed a punch dust container 21. After the punching, the stopper 20 is released so that the sheet is conveyed to a further downstream portion.

The sheet is conveyed to an alignment tray 22. A plurality of sheets to be bound in book form are received, aligned, and stacked sheet by sheet on the alignment tray 22. The alignment tray 22 includes a jogger 23 to align the sheets and a tap roller 24 to press each sheet in the sheet conveyance direction. On the alignment tray 22, the sheets are aligned along a fence in the sheet conveyance direction and using the jogger 23 in the lateral direction.

After a certain number of sheets to be bound in book form are stacked and aligned on the alignment tray 22, clamps 25 press and hold a portion near a bound portion of the sheets. A ring cartridge holder 26 holds a ring cartridge including a number of rings 28.

A ring binding unit 29 is pivoted to a position below the ring cartridge 27 to load a ring 28. While holding the ring 28, the ring binding unit 29 pivots to a position below the clamps 25, passes the ring 28 into a hole formed at a lower end portion of a bundle of sheets, and binds the sheets with the ring 28 into a book B using a binding mechanism. When a pivotable bundle conveyance member 30 pivots to a position below the clamps 25, the clamps 25 are released. The book bound with the ring 28 is received by a discharge hook 31 disposed on a belt of the bundle conveyance member 30 and thus transferred onto the bundle conveyance member 30.

The bundle conveyance member 30 rotates in the counter-clockwise direction in FIG. 2 to such a position as to be substantially in line with a final bundle conveyance member 32. The book is transferred to the final bundle conveyance member 32 using the discharge hook 31. From the final bundle conveyance member 32, the book is conveyed and output to the output tray 4 using a discharge hook 33 disposed on a belt of the final bundle conveyance member 32. Thus, a series of book binding processes are performed.

When a punch hole is already formed in a sheet fed from the image forming apparatus 1, the binder 3 detects the punch hole using a sensor provided at, for example, a portion of the horizontal path 10. As described above, in this embodiment, the reverse rollers 11 switch back the conveyance direction of sheet. Accordingly, at a portion at which a sheet stops for switchback, the binder 3 may detect whether or not a punch hole is formed in the sheet using a reflection sensor.

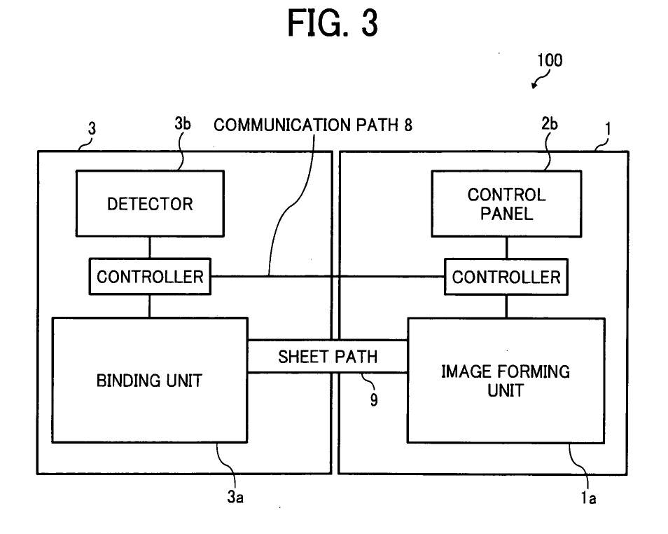

FIG. 3 is a block diagram illustrating a schematic configuration of the book-binding system according to this illustrative embodiment.

When the image forming apparatus 1 of the book-binding system 100 illustrated in FIG. 3 receives data for printing and book binding from, e.g., a personal computer (hereinafter “PC”) through a network or other communication medium, it executes image formation on sheets in an image forming unit 1a. The sheets, on which images have been formed, are forwarded through a sheet path to the binder 3, and a binding unit 3a executes the above-described processing, such as ring binding, on the sheets.

In FIG. 3, separate controllers to control the image forming apparatus 1 and the binder 3 receive and transmit information via a communication path 8, and acquire, using a detector 3b, various information on binding consumables mounted to the binder 3, such as the type, size, color, or a combination of the foregoing characteristics, and information on the sheets fed from the image forming apparatus 1 such as the size, number of stacked sheets (thickness), and other properties.

An operation unit displays the information acquired by the detector 3b in a selectable manner, and a user selects desired information and inputs an instruction for binding. The operation unit may be provided in the binder 3, or the control panel 2b of the image forming apparatus 1 illustrated in FIG. 1 may have the functions of the operation unit. Alternatively, a printer driver for control programs operative on a PC that transmits data for printing and book binding may have a function screen for displaying and inputting binding-related information as a portion of an operation screen for specifying various settings of the image forming apparatus 1.

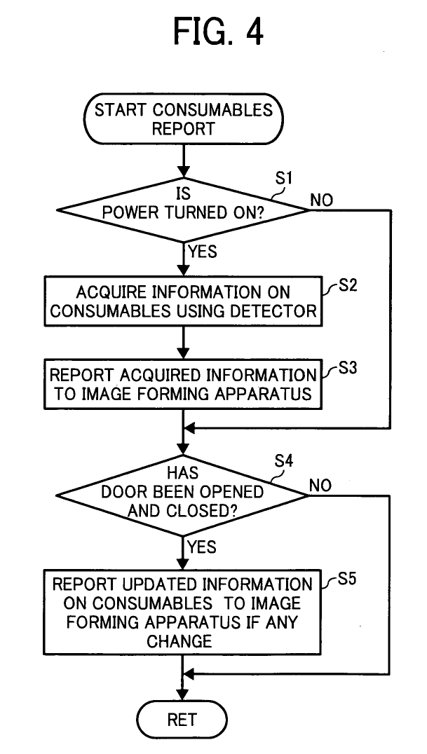

Next, acquisition of consumable information depending on sheets when binding according to this illustrative embodiment is described with reference to FIG. 3 and a flow chart shown in FIG. 4.

In FIG. 4, at S1 it is determined whether or not the image forming apparatus is in an initial state after power is turned on.

If the image forming apparatus is in the initial state (“YES” at S1), the detector 3b acquires information on consumables mounted in the binder 3. At this time, for the consumables mountable in the binder 3, the detector 3b detects whether or not each of the mountable consumables is currently mounted in the binder 3 and, if any, the type and amount of currently mounted consumables.

At S3, the controller of the binder 3 transmits the acquired information through the communication path 8 to the controller of the image forming apparatus 1, and updates a consumables list prepared in advance and stored in a storage unit. The storage unit to store the list may be a storage unit accompanied with the controller to store control programs for controlling the image forming apparatus and various parameters, or may be provided independently of the accompanied storage unit. Alternatively, information in the list may be stored in either the image forming apparatus 1 or the binder 3.

At S4, it is determined whether or not a door of the binder 3 has been opened and closed.

If the door has been opened and closed (“YES” at S4), there is a possibility that substitution, replenishment, or other operation may have been performed on consumables in the binder 3. Accordingly, at S5 the detector 3b reacquires information on consumables and updates the consumables list.

By contrast, if the image forming apparatus 1 is not in the initial state (“NO” at S1), the above-described steps S2 and S3 are skipped and the process goes to S4.

At this time, when a plurality of types of consumables mounted in the binder 3 is mounted in one cartridge, the detector 3b acquires information on each of the consumables. At this time, for example, ring size and diameter may be determined in a conventionally known manner. When the apparatus is powered on or the door is opened and closed, the information thus acquired is reported to the image forming apparatus 1, thereby allowing the book-binding system 100 to recognize which types of consumables are currently mounted therein.

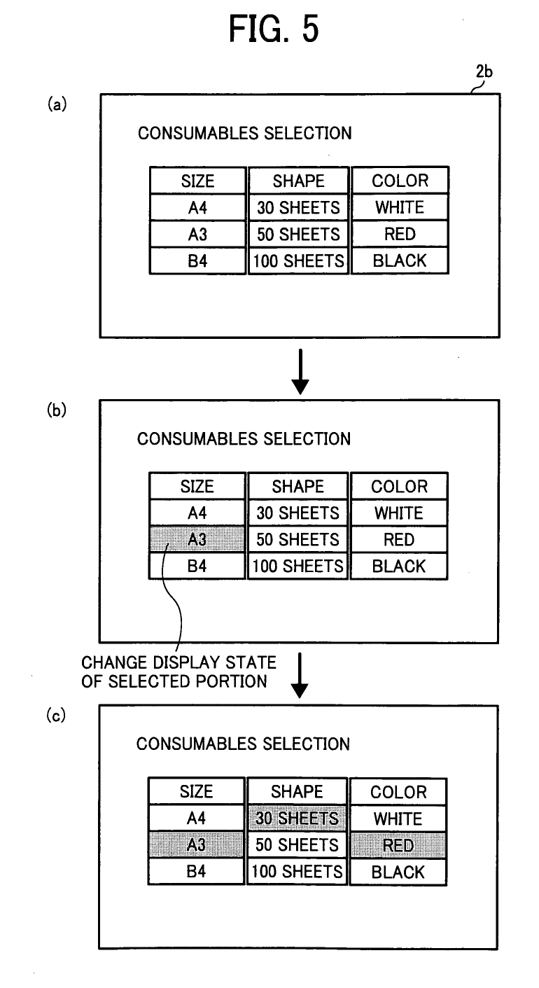

As illustrated in (a) in FIG. 5, a screen of the control panel 2b of the image forming apparatus 1 displays information on consumables so that a user can select desired information. The information on consumables is acquired from the consumables list using the detector 3b. When a consumable type is selected from a plurality of consumable types displayed on the screen, as illustrated in FIGS. 5b and 5c, the display state, such as color, brightness, flashing, etc., of a selected portion is changed so that a user can more easily recognize the selected portion. Thus, the information on consumables mounted in the binder 3 is displayed on the control panel 2b, allowing the consumable used for book binding to be reliably confirmed and selected.

Further, as one selection example of consumable, (c) in FIG. 5 illustrates a state in which a “consumable for A3 sheet size, 30 sheets, and red” is selected.

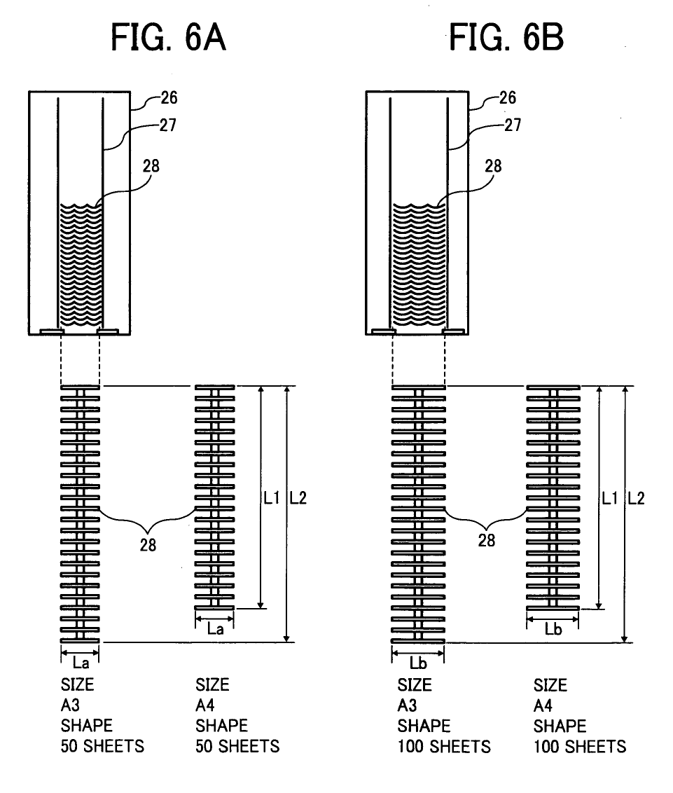

As illustrated in FIGS. 6A and 6B, the ring cartridge holder 26 is capable of storing a plurality of types of rings 28 corresponding to a plurality of sizes and numbers of sheets subjected to binding with the rings 28. FIG. 6A illustrates two types of rings for A3 sheet size and 50 sheets and for A4 sheet size and 50 sheets, and FIG. 6B illustrates two types of rings for A3 sheet size and 100 sheets and for A4 sheet size and 100 sheets

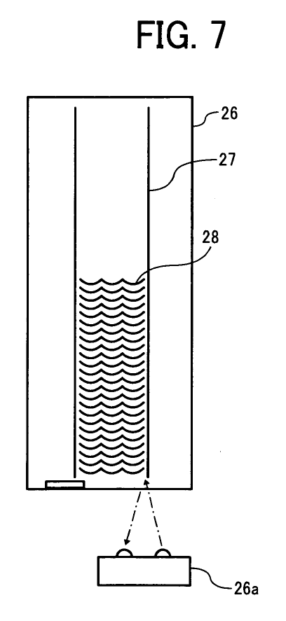

As a method of detecting the presence or absence or the size of rings 28 stored in the ring cartridge 27, for example, the reflection sensor 26a illustrated in FIG. 7 detects an end portion of one ring 28 to determine the length of La or Lb as illustrated in FIGS. 6A and 6B, and acquire information on the bindable number of sheets, the presence or absence of the rings 28, or the like. Further, using substantially the same configuration as that described above makes it possible to identify which sheet sizes are bindable with the ring 28, such as L1 and L2 illustrated in FIGS. 6A and 6B.

The reflection sensor 26a may be provided in either the ring cartridge holder 26 or the ring binding unit 29. In such cases, when the ring binding unit 29 rotates to a position below the ring cartridge 27 to load a ring 28, the information on the bindable number of sheets or the presence or absence of the ring 28 is acquired using the reflection sensor 26a.

The detector may acquire information on sheets to be bound into a book from information attached to data for printing and book-binding, such as the number of copies to be printed, number of sheets to be printed, and sheet size. Alternatively, a sensor may acquire the number of sheets having passed through the horizontal path 10 of the binder 3 or the size and thickness of sheets whose lateral side has been aligned by the jogger 14 of the alignment tray 13. Further, the acquired information on sheets may be displayed in a manner similar to the case of the above-described consumables.

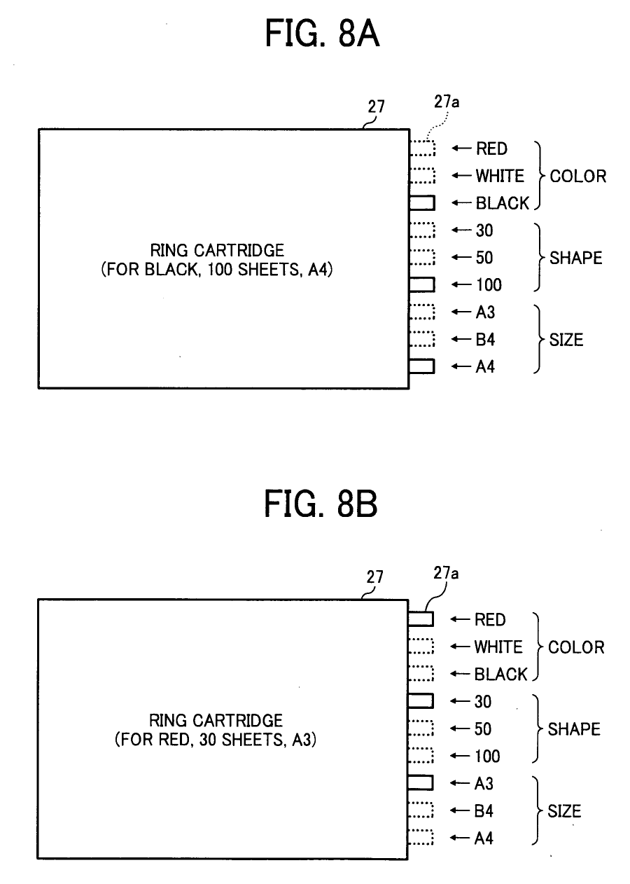

In a conventional technology for detecting consumables replacement or the like, a plurality of cartridge housings for storing consumables have different shapes so that the consumable type is determined by detecting the difference in shape between the cartridge housings. For example, as illustrated in FIGS. 8A and 8B, tabs 27a indicating various information, such as color of consumable (e.g., ring) and the number and size of sheets to be bound, are placed at different positions of the ring cartridge 27 indicating the respective information, which is acquired by a sensor provided in the ring cartridge holder 26.

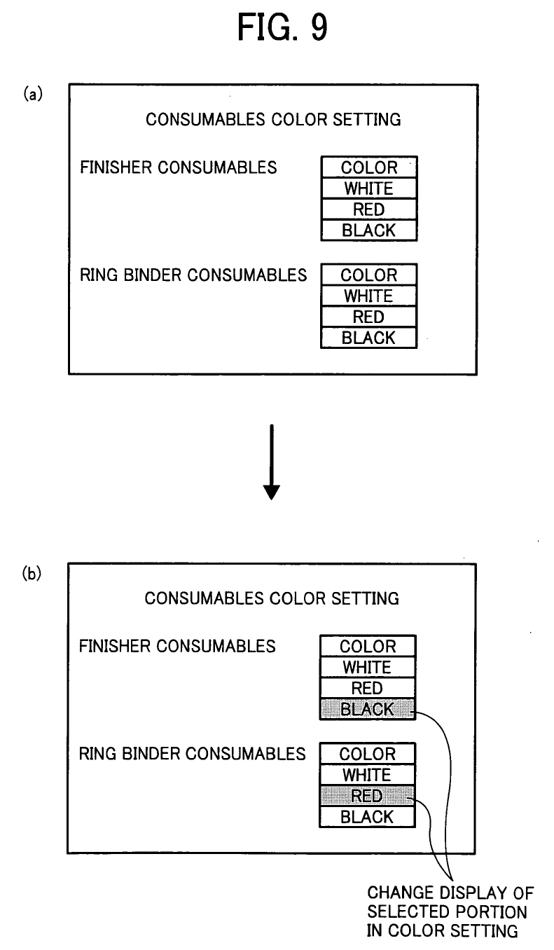

According to this illustrative embodiment, when the ring cartridge 27 is replaced with another ring cartridge or operated for consumables replacement or the like, a screen for setting a color for a consumable (e.g., a ring) in the ring cartridge 27 as illustrated in FIG. 9(a) is displayed depending on a signal indicating that the door of the binder 3 has been opened and closed. When a user inputs information from the screen, consumable information in a corresponding portion of the consumables list is updated. Such configuration allows the book-binding system 100 to recognize such information as consumable color, which is difficult for the system to identify. As described above, in the input screen of FIG. 9(a) as well, changing the display state of an input item allows a user to more easily recognize the input item as illustrated in FIG. 9(b).

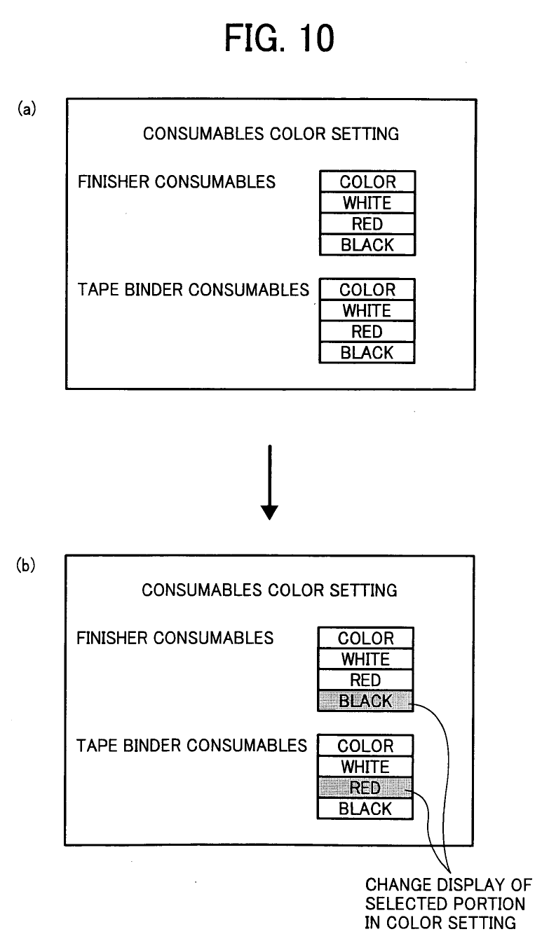

As illustrated in FIGS. 10(a) and 10(b), when tape is used instead of a ring, operation as described above is still executable. When a screen, illustrated in FIG. 10(a), for setting a color for a consumable (in this case, tape) in a cartridge is displayed, a user can input a color from the screen to update the corresponding consumable information. Further, on the input screen illustrated in FIG. 10(a) as well, the display state of an input item is changed so as to become more easily recognizable as illustrated in FIG. 10(a). In the book-binding system 100 illustrated in FIG. 1, such tape-binding binder 3 may be further connected to the ring-binding binder 3.

Compared to a configuration in which the type of consumable is determined by identifying the shape of a cartridge storing the consumable, a configuration like that described above facilitates an increase in the number of types of consumables that can be stored in the cartridge, thereby allowing a user to select a desired consumable type from a broader range of consumable types.

For example, every time consumable-related operation is performed in the binder 3, the screen for setting consumable color may be displayed to prompt a user to input a color, and the binder 3 may be configured to enter a usable state after the user inputs a color.

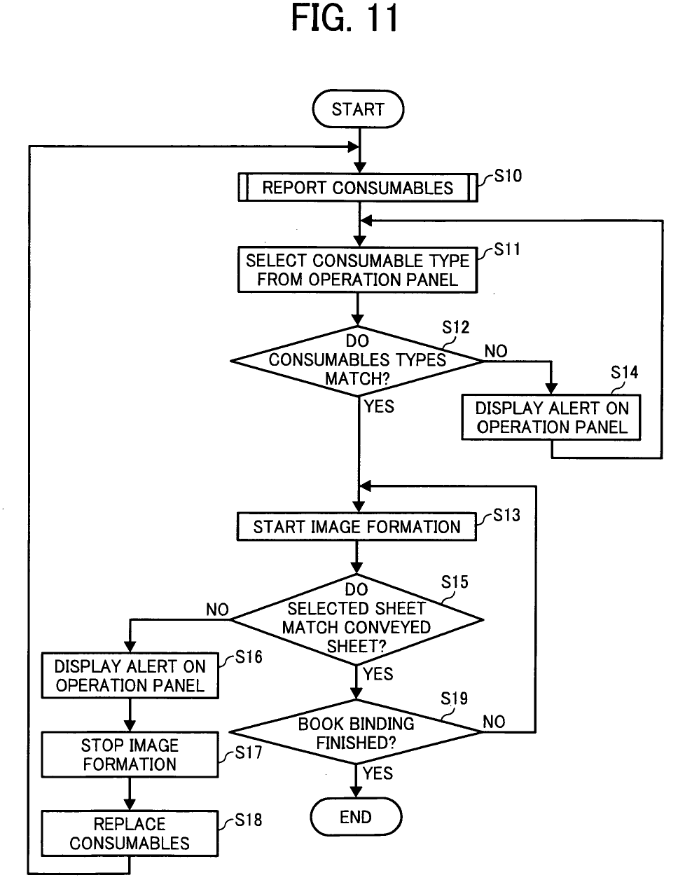

FIG. 11 is a flow chart illustrating a procedure for selecting a consumable-type depending on the sheets when executing binding process according to this illustrative embodiment. A description is given of the flow chart illustrated in FIG. 11 with reference to FIG. 3.

At S10, when the power is turned on, the above-described consumable information report illustrated in FIG. 4 is executed.

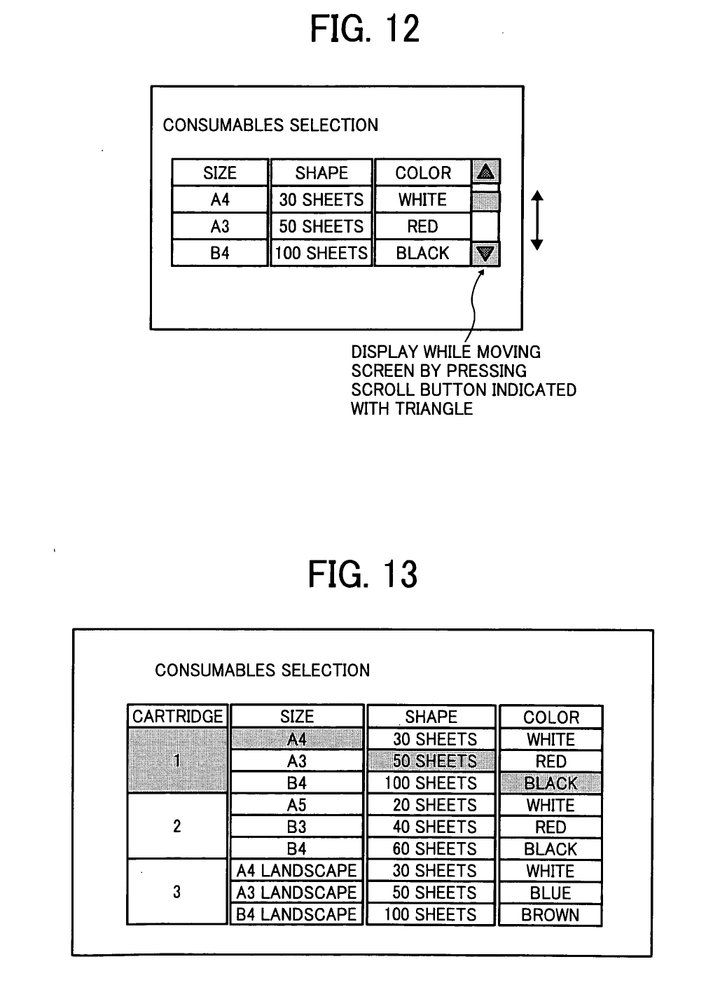

When printing and book-binding are performed, at S11 a user selects and inputs a consumable type from a selection screen displayed on the control panel 2b of the image forming apparatus 1 based on information sent from the binder 3. The selection screen performs a series of screen displays as illustrated in FIG. 5a to 5c, and likewise, a display state of selected portion is changed so that a user can more easily recognize the selected portion. Alternatively, as illustrated in FIG. 12, a limited number of items may be displayed so that other items can be displayed in turn using scroll buttons. Such configuration allows a large number of types of selectable consumables to be displayed in a relatively small display area.

With the above-described binder 3 illustrated in FIG. 2, only one consumable type is described with reference to the rings 28, the ring cartridge 27, and the ring cartridge holder 26. It is to be noted that a plurality of ring cartridges 27 may be movably disposed in the ring cartridge holder 26 so that a user can select a desired one of the ring cartridges 27. Alternatively, a plurality of ring cartridge holders 26 may be mounted in the binder 3 so that a user can select a desired one of the ring cartridge holders 26. In such cases, a consumables selection screen may perform screen display as illustrated in FIG. 13 to display all consumable types mountable in the binder 3. Alternatively, using a selection screen illustrated in FIG. 12 allows a relatively large number of consumable types to be displayed.

When a consumable type is selected and input from a selection screen, at S12 it is determined whether or not the selected consumable type matches a consumable type mounted in the binder 3.

If the selected type of consumable is mounted in the binder 3 (“YES” at S12), at S13 printing is performed depending on data transmitted from a PC or the like.

By contrast, if the selected type of consumable is not mounted in the binder 3 (“NO” at S12), at S14 a selection error is reported through the control panel 2b to alert a user.

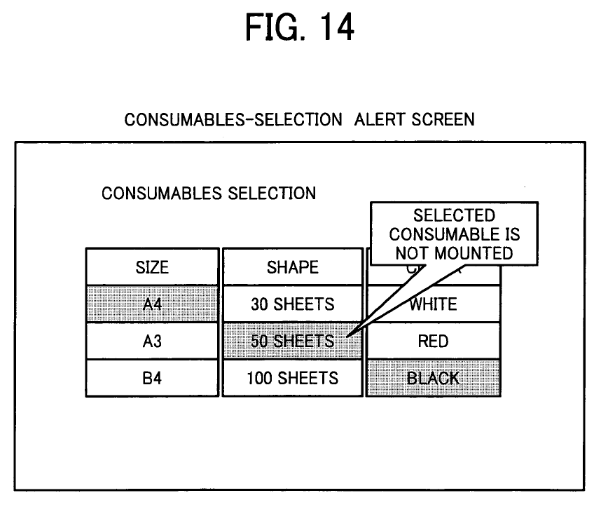

As a method for reporting such alert, an LED (light emitting diode) or lamp in the control panel 2b may light up or flash. As another method, an error message may be displayed on a selection screen as illustrated in FIG. 14, or a speaker provided in the control panel 2b may sound an alarm. Alternatively, several of the foregoing methods may be combined.

In the display of all mountable types of consumables illustrated in FIG. 13, reporting an alert as illustrated in FIG. 14 allows a user to confirm whether or not a desired consumable is mountable or currently mounted in the binder 3.

When image formation is started at S13, at S15 it is determined whether or not sheet information of the selected consumable type matches information on sheets conveyed from the image forming apparatus 1.

If the two pieces of information do not match (“NO” at S15), at S16 an alert is reported through the control panel 2b.

At S17, the image formation is stopped, and at S18 consumables replacement are performed.

Then, the process returns to S10, and the consumables report is performed.

With this process flow, determination of the remaining amount of consumables is also executable in addition to the above-described sheet information matching.

If the two pieces of information match (“YES” at S15), at S19 it is determined whether or not image formation for book binding is finished.

If the image formation is not finished (“NO” at S19), the process returns to S13, and subsequently executes book binding.

If the image formation is finished (“YES” at S19), the process ends.

In a PC that transmits data for book binding to the image forming apparatus 1, consumable information transferred from the binder 3 to the image forming apparatus 1 may be transmitted to a printer driver operative on the PC that is capable of controlling printing and usable to input settings of the image forming apparatus 1, so that a selection screen of consumables for book binding is displayed in a selectable manner through the printer driver.

According to this illustrative embodiment, in the control panel 2b of the image forming apparatus 1 and the printer driver operative on the PC, a user-friendly selection screen as described above is displayed to clearly inform a user of consumable type, thereby improving ease of operation.

As described above, when a user instructs book binding, the book-binding system 100 according to this illustrative embodiment displays information on consumables mounted in the image forming apparatus 1 on the control panel 2b in a selectable manner. Such configuration allows a user to easily select a desired type of consumable from a plurality of types of consumables and can improve operability in selecting such a consumable, thereby facilitating input of settings in the book binding system.

Illustrative embodiments being thus described, it should be apparent to one skilled in the art after reading this disclosure that the examples and embodiments may be varied in many ways. Such variations are not to be regarded as a departure from the spirit and scope of the present invention, and such modifications are not excluded from the scope of the following claims.

What is claimed is:

1. A book-binding system, comprising:
an image forming apparatus configured to form images on a plurality of sheets;
a binder connectable to the image forming apparatus and configured to bind with a binding member the plurality of sheets on which the images are formed by the image forming apparatus;
a detector configured to acquire information on the plurality of sheets fed from the image forming apparatus to the binder and information on consumables used to bind the plurality of sheets; and
an operation unit configured to display the information on the consumables in a selectable manner for input;
wherein the input from the operation unit allows selection of consumables depending on the number and type of sheets bound in the binder.

2. The book-binding system according to claim 1, wherein the binding member is any one of staple, ring, and tape.

3. The book-binding system according to claim 1, wherein the information on consumables displayed in the selectable manner on the operation unit includes at least one of size and number of the plurality of sheets.

4. The book-binding system according to claim 1, wherein the information on consumables displayed on the operation unit includes colors of the consumables corresponding to types of the consumables.

5. The book-binding system according to claim 3, wherein, when information on sheets selected from the information on consumables displayed on the operation unit does not match the information on the plurality of sheets fed from the image forming apparatus to the binder, image formation on the sheets fed from the image forming apparatus is stopped and an alert is reported through the operation unit.

6. The book-binding system according to claim 1, wherein the operation unit displays information on consumables currently mounted in the binder as the information on consumables displayed in the selectable manner on the operation unit.

7. The book-binding system according to claim 1, wherein the operation unit displays information on all consumables mountable in the binder as the information on consumables displayed in the selectable manner on the operation unit.

8. The book-binding system according to claim 6, wherein, when the operation unit displays the consumables, a first portion of the consumables is displayed in a selectable manner and a second portion of the consumables is sequentially displayed so as to replace the first portion of the consumables.

9. The book-binding system according to claim 1, wherein the operation unit reports an alert when information on the consumable selected using the operation unit does not match information on a consumable mounted in the binder.

10. The book-binding system according to claim 5, wherein the operation unit reports the alert by at least one of lighting up, flashing, display of an alert message, alert sound, and alert voice.

11. The book-binding system according to claim 1, wherein the information on consumables displayed on the operation unit is also displayed on a screen of a control program operative on an external device that transmits data used to bind the plurality of sheets,
the control program performing processing and setting on the image forming apparatus.
